(19) United States
(12) Patent Application Publication
(10) Pub. No.: US 2026/0160909 A1
(43) Pub. Date: Jun. 11, 2026

(54) METHOD AND SYSTEM FOR PERFORMING SEISMIC INVERSION USING A CONVOLUTION-BASED OBJECTIVE FUNCTION

(71) Applicant: SAUDI ARABIAN OIL COMPANY, Dhahran (SA)

(72) Inventors: Weiguang He, Beijing (CN); Yuhan Sui, Beijing (CN); Yue Du, Beijing (CN)

(73) Assignees: SAUDI ARABIAN OIL COMPANY, Dhahran (SA); ARAMCO FAR EAST (BEIJING) BUSINESS SERVICES CO., LTD., Beijing (CN)

(21) Appl. No.: 18/709,876

(22) PCT Filed: Feb. 3, 2023
(86) PCT No.: PCT/CN2023/074356

§ 371 Date: May 14, 2024

(51) Int. Cl. G01V 1/30; G01V 1/28

(52) U.S. Cl. CPC G01V 1/303; G01V 1/282; G01V 2210/67

(57) ABSTRACT

A method may include obtaining acquired seismic data based on a seismic survey regarding a geological region of interest. The method may further include generating synthetic seismic data for the geological region of interest using a forward modeling function and a velocity model. The method may further include determining an objective function using the acquired seismic data, the synthetic seismic data, and a convolution function. The method may further include determining whether the velocity model satisfies a predetermined criterion based on the objective function. The method may further include updating, in response to determining that the velocity model fails to satisfy the predetermined criterion, the velocity model using a search method and various gradients to produce an updated velocity model. The method further may further include generating a seismic image using the updated velocity model.

### BACKGROUND

Various seismic processing operations are performed on seismic data from a survey to convert time-based seismic data into a depth representation of a subsurface. For example, seismic processing operations may include surface multiple filtering and other seismic data correction operations. Likewise, seismic processing may also include application of seismic inversion techniques and migration algorithms to velocity models.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a method that includes obtaining acquired seismic data based on a seismic survey regarding a geological region of interest. The method further includes generating, by a computer processor, synthetic seismic data for the geological region of interest using a forward modeling function and a velocity model. The method further includes determining, by the computer processor, an objective function using the acquired seismic data, the synthetic seismic data, and a convolution function, wherein the objective function compares the acquired seismic data and the synthetic seismic data. The method further includes determining, by the computer processor, whether the velocity model satisfies a predetermined criterion based on the objective function. The method further includes updating, by the computer processor and in response to determining that the velocity model fails to satisfy the predetermined criterion, the velocity model using a search method and various gradients to produce an updated velocity model. The method further includes generating, by the computer processor, a seismic image using the updated velocity model.

In general, in one aspect, embodiments relate to a system that includes a seismic interpreter, which includes a computer processor and a memory. The seismic interpreter obtains acquired seismic data based on a seismic survey regarding a geological region of interest. The seismic interpreter further generates synthetic seismic data for the geological region of interest using a forward modeling function and a velocity model. The seismic interpreter further determines an objective function using the acquired seismic data, the synthetic seismic data, and a convolution function. The objective function compares the acquired seismic data and the synthetic seismic data. The seismic interpreter further determines whether the velocity model satisfies a predetermined criterion based on the objective function. The seismic interpreter further updates, in response to determining that the velocity model fails to satisfy the predetermined criterion, the velocity model using a search method and various gradients to produce an updated velocity model. The seismic interpreter further generates a seismic image using the updated velocity model.

In general, in one aspect, embodiments relate to a method that includes non-transitory computer readable medium storing instructions executable by a computer processor, the instructions when executable by the computer processor are programmed to perform a method. The method includes obtaining acquired seismic data based on a seismic survey regarding a geological region of interest. The method further includes generating synthetic seismic data for the geological region of interest using a forward modeling function and a velocity model. The method further includes determining an objective function using the acquired seismic data, the synthetic seismic data, and a convolution function. The objective function compares the acquired seismic data and the synthetic seismic data. The method further includes determining whether the velocity model satisfies a predetermined criterion based on the objective function. The method further includes updating, in response to determining that the velocity model fails to satisfy the predetermined criterion, the velocity model using a search method and various gradients to produce an updated velocity model. The method further includes generating a seismic image using the updated velocity model.

In some embodiments, an adjoint source is determined using synthetic seismic data and an objective function. Adjoint wavefield data may be determined for a geological region of interest using the adjoint source, a backpropagation function, and a velocity model. One or more gradients may be determined using the adjoint wavefield data, wherein the velocity model is updated using one or more gradients. In some embodiments, acquired seismic data include a first set of seismic traces and synthetic seismic data include a second set of seismic traces. An objective function may be determined by performing a convolution of the first set of seismic traces and the second set of seismic traces using the convolution function. In some embodiments, a selection of a seismic trace is determined from acquired seismic data. A predetermined number of neighboring traces may be determined for a convolution function. A convolution of the seismic trace with various seismic traces from synthetic seismic data may be determined based on the predetermined number of neighboring traces and the convolution function. In some embodiments, an objective function is determined using a Fast Fourier Transform. In some embodiments, a search method is selected from among a conjugate-gradient method and a quasi-Newton 1-bfgs method. In some embodiments, a predetermined criterion is a convergence criterion. In some embodiments, a convolution function includes one or more convolution filters that produce a synthetic seismic trace from a convolution of the convolution function and an acquired seismic trace. In some embodiments, a velocity model is updated iteratively until a predetermined criterion is satisfied. In some embodiments, a presence of hydrocarbons is determined using a seismic image in the geological region of interest. In some embodiments, acquired seismic data is acquired regarding a geological region of interest using a seismic surveying system.

In light of the structure and functions described above, embodiments of the invention may include respective means adapted to carry out various steps and functions defined above in accordance with one or more aspects and any one of the embodiments of one or more aspect described herein.

Other aspects of the disclosure will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1 and 2 show systems in accordance with one or more embodiments.

FIG. 3 shows a flowchart in accordance with one or more embodiments.

FIGS. 4, 5, 6, 7, 8, 9, 10, 11, 12, 13A, and 13B show examples in accordance with one or more embodiments.

FIG. 14 shows a computing system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include systems and methods for performing seismic inversion using a convolution-based objective function that is determined based on deconvolving synthetic and acquired seismic data. For example, a convolution-based objective function may be determined from convolutions between selected seismic traces and convolution filters. In some embodiments, for example, the similarity between adjacent seismic traces may be measured in the time domain or frequency domain in order to generate a particular objective function. A convolution-based objective function may be used for different seismic inversion processes, such as full waveform inversion (FWI), to determine or update a velocity model describing a particular geological region. In particular, the objective function may be based on various deconvolution methods among neighboring seismic traces in a synthetic seismic dataset or an acquired seismic dataset. In other words, some embodiments determine convolution filters between neighboring seismic traces for both synthetic and acquired seismic data (e.g., shot gathers). Afterwards, the objective function is generated based on the similarity of those convolution functions. Likewise, the resulting objective function may be more convex than a conventional least-square objective function. In this convolution-based objective function, the inter-receiver coherency among the synthetic and acquired seismic traces may also be exploited accordingly to determine a global minimum for an optimized velocity model.

Furthermore, some seismic inversion processes require a sufficiently accurate initial velocity model to determine a final velocity model that accurately describe a geological region. Without an accurate initial velocity model, the seismic inversion process may become trapped at a local minimum during the optimization process. As such, this local minimum may produce a velocity model that does not accurately describe the corresponding geological region, and this phenomenon may be referred to as “cycle skipping.” Cycle skipping may occur because seismic data are oscillatory. For example, conventional least-squares objective functions can measure the deviation of both amplitude and phases between synthetic and acquired seismic data, but may also suffer from cycle-skipping issues.

Where the optimization algorithm seeks a final model that maximizes the zero lag of the cross-correlation of acquired data and synthetic data, the optimization algorithm may provide a model that is a good match between the acquired and synthetic data, but where the data is misaligned in time by approximately an integer number of wave cycles. This cycle-skipped model may represent a local minimum in some conventional objective functions. Any perturbation of this inaccurate model (e.g., using gradients) may only worsen the velocity model's fit to the acquired seismic data. However, applying such gradients may actually improve the velocity model's fit to the actual geological region even if decreases the fit to the acquired seismic data. By using a convolution-based objective function, cycle-skipping may be alleviated in the optimization process.

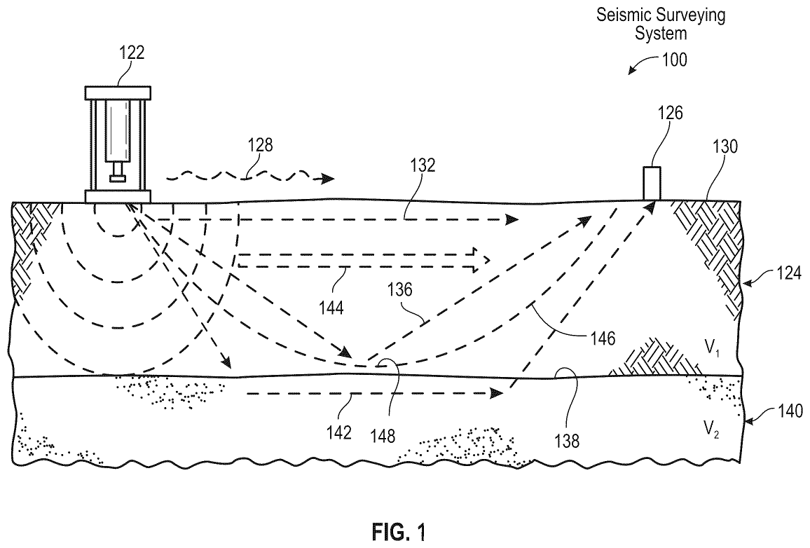

Turning to FIG. 1, FIG. 1 shows a schematic diagram in accordance with one or more embodiments. As shown in FIG. 1, FIG. 1 illustrates a seismic surveying system (100) and various resultant paths of pressure waves (also called seismic waves). The seismic surveying system (100) includes a seismic source (122) that includes functionality for generating pressure waves, such as a reflected wave (136), refracting wave (142), or diving wave (146), through a subsurface layer (124). Pressure waves generated by the seismic source (122) may travel along several paths through a subsurface layer (124) at a velocity V₁ for detection at a number of seismic receivers (126) along the line of profile. Likewise, velocity may refer to multiple velocities types, such as the two types of particle motions resulting from a seismic wave, i.e., velocity of the primary wave (P-wave) and a different velocity of the secondary wave (S-wave) through a particular medium. The seismic source (122) may be a seismic vibrator, such as one that uses a vibroseis technique, an air gun in the case of offshore seismic surveying, explosives, etc. The seismic receivers (126) may include geophones, hydrophones, accelerometers, and other sensing devices. Likewise, seismic receivers (126) may include single component sensors and/or multi-component sensors that measure pressure waves in multiple spatial axes.

As shown in FIG. 1, the seismic source (122) generates an air wave (128) formed by a portion of the emitted seismic energy, which travels above the earth's surface (130) to the seismic receivers (126). The seismic source (122) may also emit surface waves (132), which travel along the earth's surface (130). The speed of the surface waves (132), also called Rayleigh waves or ground roll, may correspond to a velocity typically slower than the velocity of a secondary wave. While the seismic surveying shown in FIG. 1 is a two-dimensional survey along a seismic profile along a longitudinal direction, other embodiments are contemplated, such as three-dimensional surveys.

Furthermore, subsurface layer (124) has a velocity V₁, while subsurface layer (140) has a velocity V₂. In words, different subsurface layers may correspond to different velocity values. In particular, a velocity may refer to the speed that a pressure wave travels through a medium, e.g., diving wave (146) that makes a curvilinear ray path (148) through subsurface layer (124). Velocity may depend on a particular medium's density and elasticity as well as various wave properties, such as the frequency of an emitted pressure wave. Where a velocity differs between two subsurface layers, this seismic impedance mismatch may result in a seismic reflection of a pressure wave. For example, FIG. 1 shows a pressure wave transmitted downwardly from the seismic source (122) to a subsurface interface (138), which becomes a reflected wave (136) transmitted upwardly in response to the seismic reflection. The seismic source (122) may also generate a direct wave (144) that travels directly from the seismic source (122) at the velocity V₁ through the subsurface layer (124) to the seismic receivers (126).

Turning to refracted pressure waves and diving pressure waves, the seismic source (122) may also generate a refracted wave (i.e., refracting wave (142)) that is refracted at the subsurface interface (138) and travels along the subsurface interface (138) for some distance as shown in FIG. 1 until traveling upwardly to the seismic receivers (126). As such, refracted pressure waves (e.g., refracted wave (142) may be analyzed to map the subsurface layers (124, 140). For example, a refracted wave is a wave that a portion of ray path is along an interface of a reflector as show in refracting wave (142) in FIG. 1 (i.e., refraction exists only when V₂>V₁). On the other hand, a diving wave may be generated where velocities are gradually increasing with depth at a gradient (e.g., diving wave (146)), such that the diving wave may turn back along curvilinear ray path. Likewise, the apex of a diving wave may be consistent with a reflected seismic wave in a common midpoint (CMP) gather.

Furthermore, in analyzing seismic data acquired using the seismic surveying system (100), seismic wave propagation may be approximated using rays. For example, reflected waves (e.g., reflected wave (136) and diving waves (e.g., diving wave (146)) may be scattered at the subsurface interface (138). In FIG. 1, for example, the diving wave B (146) may exhibit a ray path of a wide angle that resembles a reflected wave in order to map the subsurface. Using diving waves, for example, a velocity model for an underlying subsurface may be generated that describes the velocity of different regions in different subsurface layers. An initial velocity model may be generated by modeling the velocity structure of media in the subsurface using an inversion of seismic data, typically referred to as seismic inversion. In seismic inversion, a velocity model is iteratively updated until the velocity model and the seismic data have a minimal amount of mismatch, e.g., the solution of the velocity model converges to a minimum that satisfies a predetermined criterion. For example, the optimization algorithm may be “linearized” and while achieving a “minimum”, there may be no guarantee that it is a global minimum rather than a local minimum. Thus, it may be a simplification commonly adapted in solving inverse problems that works when a respective objective function is convex.

With respect to velocity models, a velocity model may map various subsurface layers based on velocities in different layer sub-regions (e.g., P-wave velocity, S-wave velocity, and various anisotropic effects in the sub-region). For example, a velocity model may be used with P-wave and S-wave arrival times and arrival directions to locate seismic events. Anisotropy effects may correspond to subsurface properties that cause pressure waves to be directionally dependent. Thus, seismic anisotropy may correspond to various parameters in geophysics that refers to variations of wave velocities based on direction of propagation. One or more anisotropic algorithms may be performed to determine anisotropic effects, such as an anisotropic ray-tracing location algorithm or algorithms that use deviated-well sonic logs, vertical seismic profiles (VSPs), and core measurements. Likewise, a velocity model may include various velocity boundaries that define regions where rock types change, such as interfaces between different subsurface layers. In some embodiments, a velocity model is updated using one or more tomographic updates to adjust the velocity boundaries in the velocity model.

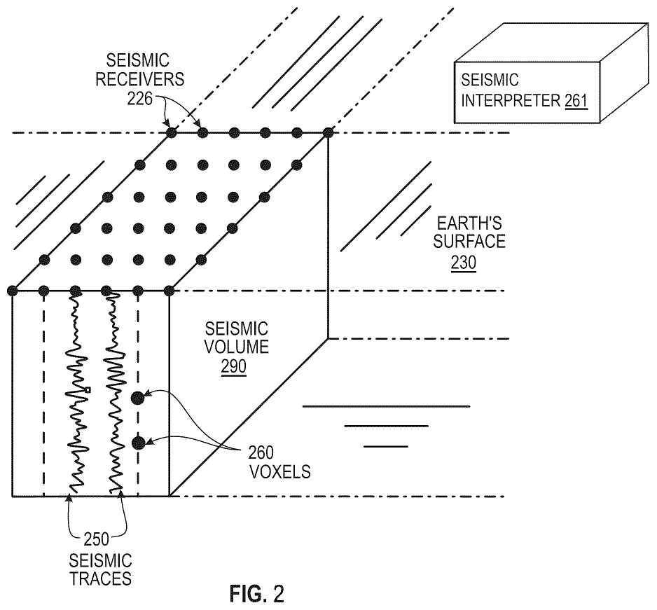

Turning to FIG. 2, FIG. 2 illustrates a system in accordance with one or more embodiments. As shown in FIG. 2, a seismic volume (290) is illustrated that includes various seismic traces (e.g., seismic traces (250)) acquired by various seismic receivers (e.g., seismic receivers (226)) disposed on the earth's surface (230). More specifically, a seismic volume (290) may be a cubic dataset of seismic traces. In particular, seismic data may have up to four spatial dimensions, one temporal dimension (i.e., related to the actual measurements stored in the traces), and possibly another temporal dimension related to time-lapse seismic surveys. Individual cubic cells within the seismic volume (290) may be referred to as voxels or volumetric pixels (e.g., voxels (260)). In particular, different portions of a seismic trace may correspond to various depth points within a volume of earth. To generate the seismic volume (290), a three-dimensional array of seismic receivers (226) are disposed along the earth's surface (230) and acquire seismic data in response to various pressure waves emitted by seismic sources. Within the voxels (260), statistics may be calculated on first break data that is assigned to a particular voxel to determine multimodal distributions of wave traveltimes and derive traveltime estimates (e.g., according to mean, median, mode, standard deviation, kurtosis, and other suitable statistical accuracy analytical measures) related to azimuthal sectors. First break data may describe the onset arrival of refracted waves or diving waves at the seismic receivers (226) as produced by a particular seismic source signal generation.

Seismic data may refer to raw time domain data acquired from a seismic survey (e.g., acquired seismic data may result in the seismic volume (290)). However, seismic data may also refer to data acquired over different periods of time, such as in cases where seismic surveys are repeated to obtain time-lapse data. Seismic data may also refer to various seismic attributes derived in response to processing acquired seismic data. Furthermore, in some contexts, seismic data may also refer to depth data or image data. Likewise, seismic data may also refer to processed data, e.g., using a seismic inversion operation, to generate a velocity model of a subterranean formation, or a migrated seismic image of a rock formation within the earth's surface. Seismic data may also be pre-processed data, e.g., arranging time domain data within a two-dimensional shot gather.

Furthermore, seismic data may include various spatial coordinates, such as (x,y) coordinates for individual shots and (x,y) coordinates for individual receivers. As such, seismic data may be grouped into common shot or common receiver gathers. In some embodiments, seismic data is grouped based on a common domain, such as common midpoint (i.e., Xmidpoint=(Xshot+Xrec)/2, where Xshot corresponds to a position of a shot point and Xrec corresponds to a position of a seismic receiver) and common offset (i.e., Xoffset=Xshot−Xrec).

In some embodiments, seismic data is processed to generate one or more seismic images. For example, seismic imaging may be performed using a process called migration. In some embodiments, migration may transform pre-processed shot gathers from a data domain to an image domain that corresponds to depth data. In the data domain, seismic events in a shot gather may represent seismic events in the subsurface that were recorded in a field survey. In the image domain, seismic events in a migrated shot gather may represent geological interfaces in the subsurface. Likewise, various types of migration algorithms may be used in seismic imaging. For example, one type of migration algorithm corresponds to reverse time migration. In reverse time migration, seismic gathers may be analyzed by: 1) forward modelling of a seismic wavefield via mathematical modelling starting with a synthetic seismic source wavelet and a velocity model; 2) backward propagating the seismic data via mathematical modelling using the same velocity model; 3) cross-correlating the seismic wavefield based on the results of forward modeling and backward propagating; and 4) applying an imaging condition during the cross-correlation to generate a seismic image at each time step. The imaging condition may determine how to form an actual image by estimating cross-correlation between the source wavefield with the receiver wavefield under the basic assumption that the source wavefield represents the down-going wave-field and the receiver wave-field the up-going wave-field.

In Kirchhoff and other migration methods, for example, the imaging condition may include a summation of contributions resulting from the input data traces after the traces have been spread along portions of various isochrones (e.g., using principles of constructive and destructive interference to form the image). For example, Kirchhoff migration function may be based on an integral form of a wave equation that corresponds to pressure wave displacement and a pressure wave velocity as function of three-dimensional space and time. As such, 3D prestack Kirchhoff depth migration may be characterized as the summation of various reflection amplitudes along diffraction traveltime curves to obtain the output seismic images. As such, Kirchhoff algorithms may preprocessing input seismic traces, determine traveltime tables for pressure waves using ray-tracing and a velocity model, and migrate these seismic traces. Besides Kirchhoff algorithms, other migration functions are also contemplated such as finite-difference migration, frequency-space migration, and frequency-wavenumber migration, and Stolt migration.

Furthermore, seismic data processing may include various seismic data functions that are performed using various process parameters and combinations of process parameter values. For example, a seismic interpreter may test different parameter values to obtain a desired result for further seismic processing. Depending on the seismic data processing algorithm, a result may be evaluated using different types of seismic data, such as directly on processed gathers, normal moveout corrected stacks of those gathers, or on migrated stacks using a migration function. Where structural information of the subsurface is being analyzed, migrated stacks of data may be used to evaluate seismic noise that may overlay various geological boundaries in the subsurface, such as surface multiples (e.g., strong secondary reflections that are detected by seismic receivers). As such, migrated images may be used to determine impact of noise removal processes, while the same noise removal processes may operate on gather data.

While seismic traces with zero offset are generally illustrated in FIG. 2, seismic traces may be stacked, migrated and/or used to generate an attribute volume derived from the underlying seismic traces. For example, an attribute volume may be a dataset where the seismic volume undergoes one or more processing techniques, such as amplitude-versus-offset (AVO) processing. In AVO processing, seismic data may be classified based on reflected amplitude variations due to the presence of hydrocarbon accumulations in a subsurface formation. With an AVO approach, seismic attributes of a subsurface interface may be determined from the dependence of the detected amplitude of seismic reflections on the angle of incidence of the seismic energy. This AVO processing may determine both a normal incidence coefficient of a seismic reflection, and/or a gradient component of the seismic reflection. Likewise, seismic data may be processed according to a pressure wave's apex. In particular, the apex may serve as a data gather point to sort first break picks for seismic data records or traces into offset bins based on the survey dimensional data (e.g., the x-y locations of the seismic receivers (226) on the earth surface (230)). The bins may include different numbers of traces and/or different coordinate dimensions.

Additionally, seismic imaging may be near the end of a seismic data workflow before an analysis by a seismic interpreter. The seismic interpreter may subsequently derive understanding of the subsurface geology from one or more final migrated images. In order to confirm whether a particular seismic data workflow accurately models the subsurface, a normal moveout (NMO) stack may be generated that includes various NMO gathers with amplitudes sampled from a common midpoint (CMP). In particular, a NMO correction may be a seismic imaging approximation based on calculating reflection traveltimes.

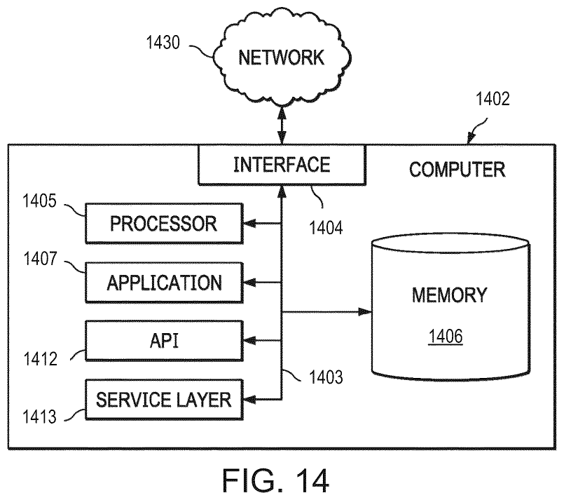

Turning to the seismic interpreter (261), a seismic interpreter (261) (also called a “seismic processing system”) may include hardware and/or software with functionality for storing the seismic volume (290), well logs, core sample data, and other data for seismic data processing, well data processing, and other data processes accordingly. In some embodiments, the seismic interpreter (261) may include a computer system that is similar to the computer (1402) described below with regard to FIG. 14 and the accompanying description. While a seismic interpreter may refer to one or more computer systems that are used for performing seismic data processing, the seismic interpreter may also refer to a human analyst performing seismic data processing in connection with a computer. While the seismic interpreter (261) is shown at a seismic surveying site, in some embodiments, the seismic interpreter (261) may be remote from a seismic surveying site.

Throughout this application, “obtain” and similar terminology is used in the context of actively or passively accessing data, such as seismic data. By way of example, a seismic interpreter may “obtain” a particular type of data (e.g., seismic data, well data, geological data, etc.) by actively transmitting a request to a remote server or a local data store to retrieve the specific data. On the other hand, a computer system may “obtain” data as a passive recipient to the data, such as through a user uploading one or more data files to a local storage device coupled to the computer system that is “obtaining” the data. In contrast, “acquire” and similar terminology is used in the context of actively harvesting data from a physical environment through sensors, electronic receivers (such as seismic receivers), and/or other hardware sensing mechanisms.

While FIGS. 1 and 2 show various configurations of components, other configurations may be used without departing from the scope of the disclosure. For example, various components in FIGS. 1 and 2 may be combined to create a single component. As another example, the functionality performed by a single component may be performed by two or more components.

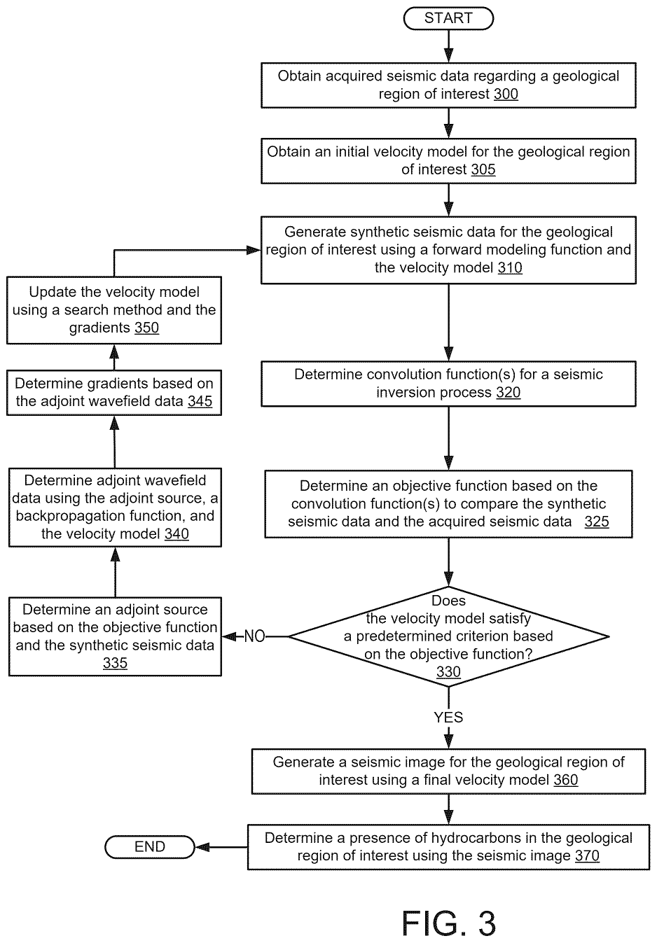

Turning to FIG. 3, FIG. 3 shows a flowchart in accordance with one or more embodiments. Specifically, FIG. 3 describes a general method for generating and/or updating a velocity model using a convolution-based objective function. One or more blocks in FIG. 3 may be performed by one or more components (e.g., seismic interpreter (261)) as described in FIGS. 1 and 2. While the various blocks in FIG. 3 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 300, acquired seismic data are obtained regarding a geological region of interest in accordance with one or more embodiments. A geological region of interest may be a portion of a geological area or volume that includes one or more formations of interest desired or selected for analysis, e.g., for determining location of hydrocarbons or reservoir development purposes. The acquired seismic data may be similar to the seismic data described above in FIGS. 1 and 2 and the accompanying description.

In Block 305, an initial velocity model is obtained for a geological region of interest in accordance with one or more embodiments. The velocity model may be similar to the velocity model described in FIGS. 1 and 2 and the accompanying description.

In Block 310, synthetic seismic data is generated for a geological region of interest using a forward modeling function and a velocity model in accordance with one or more embodiments. For example, a seismic interpreter may perform forward modeling to produce various synthetic seismograms or synthetic seismic traces over a period of time in a seismic survey. The seismic interpreter may store one or more boundary values and various step wavefields output from a forward modeling function, such as the final step wavefields. Seismic forward modeling may use ray tracing or various wave equation methods. As such, forward modeling may be performed in one, two, and three spatial dimensions. Forward modeling may also be implemented using shot gathers, common midpoint (CMP) gathers, and stacked data.

In Block 320, one or more convolution functions are determined in accordance with one or more embodiments. In some embodiments, a convolution function corresponds to one or more convolution filters for performing a convolution operation between the convolution filters and a seismic trace. For more information on convolution functions, see the accompanying description in Block 325 below.

In Block 325, an objective function is determined for a seismic inversion process based on one or more convolution functions to compare synthetic seismic data and acquired seismic data in accordance with one or more embodiments. For example, an objective function may be used in inverse modeling to determine a match between predicted data (e.g., synthetic seismic data) and observed data (e.g., acquired seismic data). As such, the objective function may describe a difference between predicted data and observed data that is minimized iteratively during a seismic inversion process. Examples of traditional objective functions include a least-squares objective functions, such as an L2-waveform objective function or a least-squares non-integration method (NIM) objective function.

In some embodiments, an objective function is determined based on one or more convolution functions based on different seismic traces. For example, a synthetic seismic trace may correspond a convolution of an acquired seismic trace and a convolution filter as expressed in the following equation:

$$conv ( {d}_{i} , {w}_{i} ) = {p}_{i} \qquad Equation ( 1 )$$

where pᵢ corresponds to an i-th synthetic seismic trace in a synthetic seismic dataset or volume, dᵢ corresponds to the i-th acquired seismic trace from an acquired seismic dataset, and wᵢ corresponds to a respective convolution filter. Thus, a convolution may be determined between a pair of a synthetic seismic trace and acquired seismic trace. While Equation (1) shows a convolution of a convolution filter and an acquired seismic trace to determine a synthetic trace, an inverse convolution, i.e., conv (pᵢ, wᵢ)=dᵢ, could also be performed.

Furthermore, synthetic seismic data may be almost identical to acquired seismic data in an ideal situation (e.g., where the velocity model for generating the synthetic seismic data provides an accurate fit to the corresponding geological region). Likewise, the convolution function may be determined using a deconvolution method in the time domain, such as with a Toeplitz solver, or in the frequency domain (e.g., using a Fourier Transform, such as a Fast Fourier Transform). In other words, the convolution filter wᵢ for each seismic trace may be the same. As such, an objective function based on a convolution filter wᵢ may be determined using the following equation:

$${h}_{ij} = \frac{\int {w}_{i} ( t ) {w}_{j} ( t ) dt}{\sqrt{\int {w}_{i}^{2} ( t ) dt} \sqrt{\int {w}_{j}^{2} ( t ) dt}} \qquad Equation ( 2 )$$

where hᵢⱼ corresponds to a normalized vector product between two convolution filters wᵢ and wⱼ, t corresponds to the time domain, and i and j correspond to different seismic traces. As such, an objection function for a pair of shot gathers (i.e., a synthetic trace gather and an acquired trace gather) may be determined using the following equation:

$$J = {\sum }_{i = 1}^{Nr} {\sum }_{j = i + 1}^{i + k} {h}_{ij} \qquad Equation ( 3 )$$

where k corresponds to a user input parameter that controls how many neighboring traces are used for comparison with a selected trace. In particular, a trace is not compared with itself because the misfit is constant, i.e., hᵢᵢ=1. While one synthetic seismic trace may be compared with all the other acquired seismic traces, the objective function may be used with a predetermined number of neighboring traces.

In Block 330, a determination is made whether a velocity model satisfies a predetermined criterion based on a comparison in accordance with one or more embodiments. For example, an amount of error between the synthetic seismic data and the acquired seismic data may be measured. This error data may describe the fit between the current velocity model (e.g., the initial velocity model or an updated velocity model from one or more optimization iterations) and the geological region of interest. Based on the amount of error that is determined between the synthetic seismic data and the acquired seismic data, the velocity model may require one or more updates to achieve a predetermined degree of accuracy in modeling the geological region of interest. Likewise, the predetermined criterion may be a stopping condition for analyzing and/or updating the velocity model. In other words, a predetermined criterion may specify a predetermined degree of error between the synthetic data produced by a velocity model and acquired seismic data. The predetermined criterion may also correspond to a predetermined number of iterations of the seismic inversion process or optimization algorithm. In some embodiments, the predetermined criterion is a convergence criterion such that the predetermined criterion is satisfied based on a seismic interpreter detecting that the amount of error has converged to a global minimum. If a determination is made that the velocity model fails to satisfy the predetermined criterion, the process may proceed to Block 335. If a determination is made that the velocity model satisfies the predetermined criterion, then the process may proceed to Block 360.

In Block 335, an adjoint source is determined based on an objective function and synthetic seismic data in accordance with one or more embodiments. In particular, an adjoint source may be determined using an objective, such as the objective function described above in Block 320. As such, an adjoint model may be solved in an iterative process using a data residual (i.e., difference between the synthetic data and acquired data) as the source of the wavefields. In a reverse time loop, an adjoint wavefield may be cross-correlated with a forward wavefield (e.g., the synthetic seismic data) using one or more time derivatives of the wavefield data. These cross-correlations may be summed to form one or more gradient values, for example. The adjoint source may also be determined using adjoint source function based on one or more adjoint wave equations.

In some embodiments, the perturbation of an objective function with respect to various convolution functions may be expressed in the following equations:

$$δ {h}_{ij} = \int {x}_{i} ( t ) δ {w}_{i} ( t ) dt + \int {z}_{j} ( t ) δ {w}_{j} ( t ) dt \qquad Equation ( 4 )$$

$$Equation ( 5 )$$

$${x}_{i} ( t ) = \frac{1}{\sqrt{\int {w}_{i}^{2} ( t ) dt} \sqrt{\int {w}_{j}^{2} ( t ) dt}} [ {w}_{j} ( t ) - {w}_{i} ( t ) \frac{\int {w}_{i} ( τ ) {w}_{j} ( τ ) d τ}{\int {w}_{i}^{2} ( t ) d τ} ]$$

$${z}_{j} ( t ) = \frac{1}{\sqrt{\int {w}_{i}^{2} ( t ) dt} \sqrt{\int {w}_{j}^{2} ( t ) dt}} [ {w}_{i} ( t ) - {w}_{j} ( t ) \frac{\int {w}_{i} ( τ ) {w}_{j} ( τ ) d τ}{\int {w}_{i}^{2} ( t ) d τ} ]$$

where wᵢ and wⱼ correspond to convolution filters, xᵢ (t) and zⱼ (t) are different seismic signals, and τ corresponds to the time constant.

Furthermore, the perturbation δwᵢ or δwⱼ may be related to the synthetic seismic data. Using Equation (1), for example, the perturbation of synthetic seismic data may be expressed using the following equation:

$$conv ( {d}_{i} , δ {w}_{i} ) = δ {p}_{i} \qquad Equation ( 6 )$$

where a solution to Equation (6) may be determined using a deconvolution method in the time domain or the frequency domain. Using a frequency domain deconvolution method, the convolution may become the product F(dᵢ)F(δwᵢ)=F(δpᵢ), which may be expressed using the following equation:

$$δ {w}_{i} = {F}^{- 1} [ \frac{{F}^{*} ( {d}_{i} )}{{F}^{*} ( {d}_{i} ) F ( {d}_{i} )} F ( δ {p}_{i} ) ] \qquad Equation ( 7 )$$

where F corresponds to a Fourier Transform, the star corresponds to a complex conjugate, and a small non-zero value may be added to the denominator of Equation (7) to maintain numerical stability. Likewise, a similar formulation could be obtained for a perturbation of a convolution function, e.g., δwⱼ, which may be expressed as the following equation:

$$\begin{matrix}δ {h}_{ij} = \int δ {p}_{i} {F}^{- 1} [ \frac{{F}^{*} ( {d}_{i} ) F ( {x}_{i} )}{{F}^{*} ( {d}_{i} ) F ( {d}_{i} )} ] dt + \int δ {p}_{j} {F}^{- 1} [ \frac{{F}^{*} ( {d}_{i} ) F ( {z}_{j} )}{{F}^{*} ( {d}_{i} ) F ( {d}_{i} )} ] dt \\ = \int δ {p}_{i} {\overline{x}}_{i} ( t ) dt + \int δ {p}_{j} {\overline{z}}_{j} ( t ) dt\end{matrix} \qquad Equation ( 8 )$$

where x̅ᵢ and z̅ⱼ are used to denote the coefficients of δpᵢ and δpⱼ, respectively. As such, an adjoint source for one shot gather may expressed as the first order differential with respect to the synthetic seismic trace using the following equation:

$$Equation ( 9 )$$

$$δ J = {\sum }_{i = 1}^{Nr} {\sum }_{j = i + 1}^{i + k} δ {h}_{ij} = {\sum }_{i = 1}^{Nr} {\sum }_{j = i + 1}^{i + k} \int δ {p}_{i} {\overline{x}}_{i} ( t ) dt + \int δ {p}_{j} {\overline{z}}_{j} ( t ) dt$$

In some embodiments, an adjoint source is determined by accumulating the contribution of x̅ᵢ to i-th trace, and z̅ⱼ to j-th trace with respect to Equation (9).

In Block 340, adjoint wavefield data are determined using an adjoint source, a backpropagation function, and a velocity model in accordance with one or more embodiments. Using a backpropagation function, forward wavefields from a final simulation time step may be backpropagated to determine adjoint wavefield data.

In Block 345, various gradients are determined based on adjoint wavefield data in accordance with one or more embodiments. For example, the gradients may correspond to various search directions, such as a direction of steeping descent as determined in a gradient-descent optimization algorithm.

In Block 350, a velocity model is updated using a search method and one or more gradients in accordance with one or more embodiments. In some embodiments, a search method is a gradient-based local optimization method, such as conjugate-gradient method or a Newton method (e.g., a quasi-Newton 1-bfgs method). Other search methods are also contemplated for updating the velocity model, such as a line search method.

In Block 360, a seismic image is generated for a geological region of interest using a final velocity model in accordance with one or more embodiments. After a final velocity model is obtained, the final velocity model may be used to obtain depth image data or reflection data of the geological region of interest. Thus, various seismic processing functions may be applied to acquired seismic data, such as migration functions. For example, a set of migrated gathers may be summed or stacked to produce a final seismic image. In some embodiments, the seismic image provides a spatial and depth illustration of a subsurface formation for various practical applications, such as predicting hydrocarbon deposits, predicting wellbore paths for geosteering, etc.

In Block 370, a presence of hydrocarbons is determined in a geological region of interest using a seismic image in accordance with one or more embodiments. For example, a seismic image may be used for lithological identification within the geological region of interest, and subsequently hydrocarbon identification.

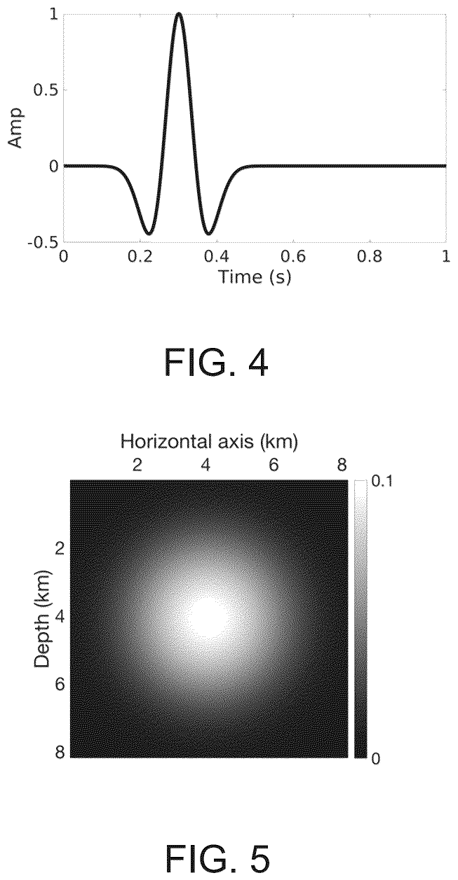

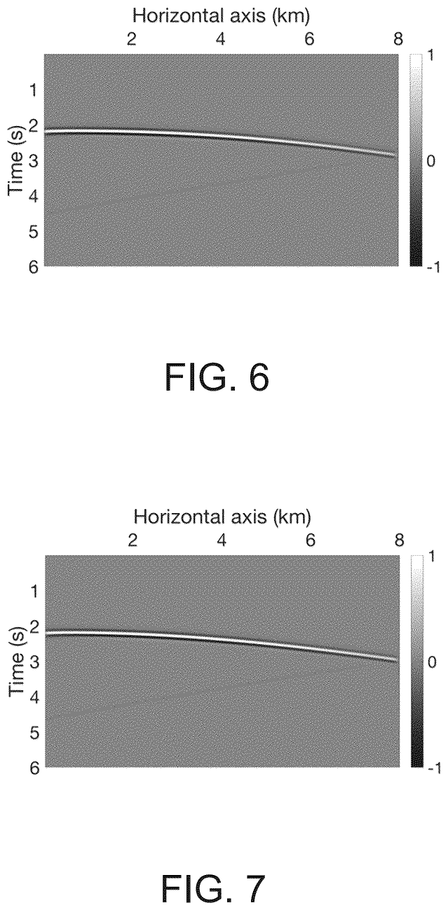

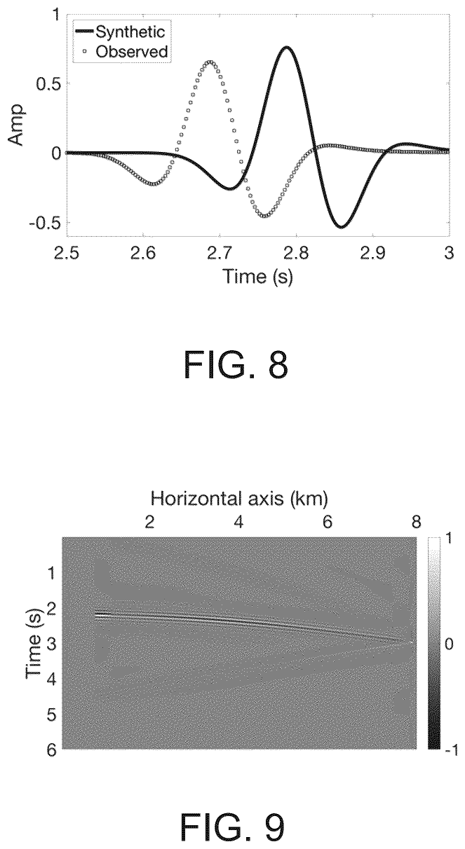

Turning to FIGS. 4, 5, 6, 7, 8, 9, 10, 11, and 12, FIGS. 4-12 illustrate examples in accordance with one or more embodiments. In FIG. 4, a source wavelet is shown being used to compute acquired seismic data, where the source wavelet is a 5 Hz Ricker wavelet. FIG. 5 shows a true velocity model structure, which is the relative variation of the true model with respect to a homogeneous background and a constant density. As such, FIG. 5 illustrates a transmission experiment with 24 source shots placed on top and 400 seismic receivers placed at the bottom of the graph. FIG. 6 shows acquired seismic data for one seismic shot. FIG. 7 shows the initial synthetic seismic data based on the velocity model and the source shots. As shown in FIG. 7, the travel time difference at long offset may be larger than the dominant period, as shown in FIG. 8. As such, FIG. 8 illustrates cycle-skipping effects when the velocity model is optimized with a conventional least-squares objective function.

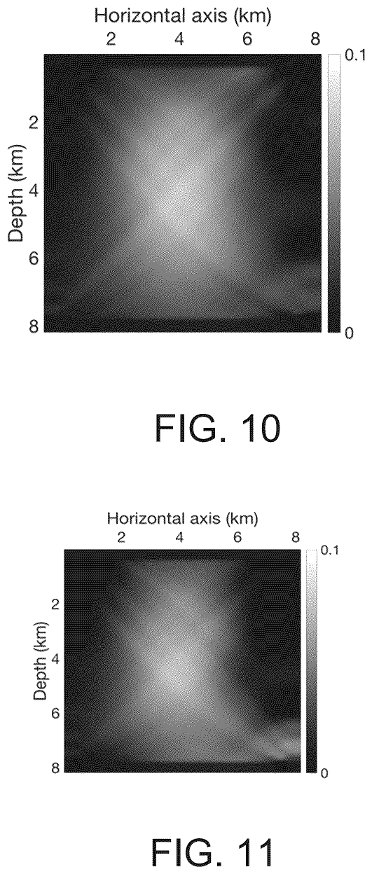

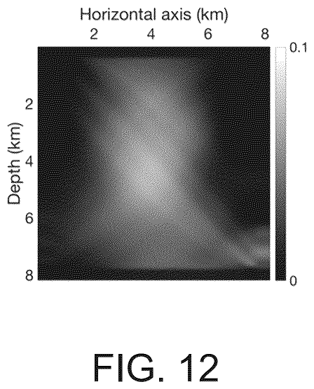

Turning to FIG. 9, an adjoint source is shown for the first source shot. The final velocity model based on an objective function as described in Block 320 above is shown being able to avoid similar cycle-skipping. In FIG. 10, twenty neighboring traces are used to compare the similarity of convolution functions. FIGS. 11 and 12 show the seismic inversion being performed with a selection of ten and five neighboring traces, respectively, which shows a velocity model that is well recovered.

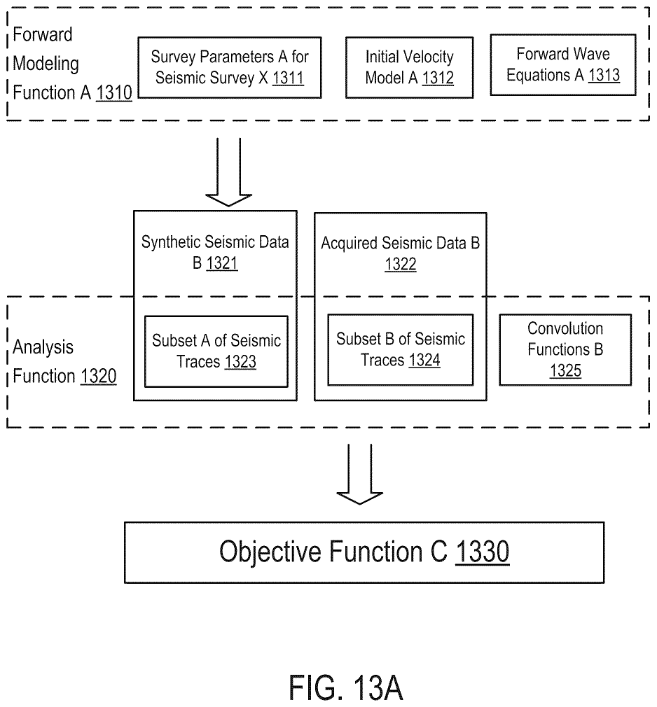

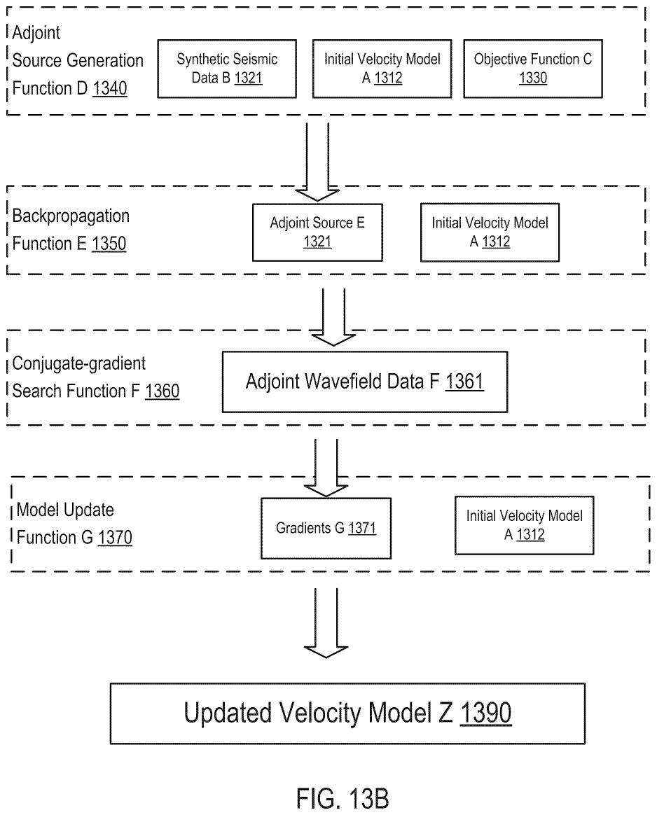

Turning to FIGS. 13A-13B, FIGS. 13A-13B provides an example of updating a velocity model using an objective function based on synthetic seismic data, acquired seismic data, and convolution functions in accordance with one or more embodiments. The following example is for explanatory purposes only and not intended to limit the scope of the disclosed technology.

In FIG. 13A, a seismic interpreter (not shown) obtains survey parameters A for seismic survey X (1311) (e.g., source and receiver locations, source frequency information, etc.) and an initial velocity model A (1312). Using a forward modeling function A (1310) and forward wave equations A (1313), the seismic interpreter uses the input data (1311, 1312) to determine synthetic seismic data B (1321). Next, the seismic interpreter applies an analysis function (1320) to a subset A of seismic traces (1323) from the synthetic seismic data B (1321) and also to a subset B of seismic traces (1324) from an acquired seismic data B (1322). The acquired seismic data B (1322) is acquired from the seismic survey X. Using convolution functions B (1325), the analysis function (1320) determines an objective function C (1330).

Turning to FIG. 13B, the seismic interpreter applies an adjoint source generation function D (1340) to the synthetic seismic data B (1321), the initial velocity model A (1312), and the objective function C (1330) to produce an adjoint source E (1321). Using the adjoint source E (1321), the seismic interpreter applies a backpropagation function E (1350) with the initial velocity model A (1312) to generate adjoint wavefield data F (1361). The seismic interpreter then uses a conjugate-gradient search function F (1360) to the adjoint wavefield data F (1361) to determine gradients G (1371). Finally, the seismic interpreter uses a model update function G (1370) based on the gradients G (1371) and the initial velocity model A (1312) to generate an updated velocity model Z (1390). The seismic interpreter may continue to iteratively update the velocity model Z (1390) using updated objective functions and updated adjoint sources until the synthetic seismic data and the acquired seismic data converge.

### Computer System

Embodiments may be implemented on a computer system. FIG. 14 is a block diagram of a computer system used to provide computational functionalities associated with described algorithms, methods, functions, processes, flows, and procedures as described in the instant disclosure, according to an implementation. The illustrated computer (1402) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1402) may include a computer that includes an input device, such as a keypad, keyboard, touch screen, or other device that can accept user information, and an output device that conveys information associated with the operation of the computer (1402), including digital data, visual, or audio information (or a combination of information), or a GUI.

The computer (1402) can serve in a role as a client, network component, a server, a database or other persistency, or any other component (or a combination of roles) of a computer system for performing the subject matter described in the instant disclosure. The illustrated computer (1402) is communicably coupled with a network (1430) or cloud. In some implementations, one or more components of the computer (1402) may be configured or programmed to operate within environments, including cloud-computing-based, local, global, or other environment (or a combination of environments).

At a high level, the computer (1402) is an electronic computing device operable to receive, transmit, process, store, or manage data and information associated with the described subject matter. According to some implementations, the computer (1402) may also include or be communicably coupled with an application server, e-mail server, web server, caching server, streaming data server, business intelligence (BI) server, or other server (or a combination of servers).

The computer (1402) can receive requests over network (1430) or cloud from a client application (for example, executing on another computer (1402)) and responding to the received requests by processing the said requests in an appropriate software application. In addition, requests may also be sent to the computer (1402) from internal users (for example, from a command console or by other appropriate access method), external or third-parties, other automated applications, as well as any other appropriate entities, individuals, systems, or computers.

Each of the components of the computer (1402) can communicate using a system bus (1403). In some implementations, any or all of the components of the computer (1402), both hardware or software (or a combination of hardware and software), may interface with each other or the interface (1404) (or a combination of both) over the system bus (1403) using an application programming interface (API) (1412) or a service layer (1413) (or a combination of the API (1412) and service layer (1413). The API (1412) may include specifications for routines, data structures, and object classes. The API (1412) may be either computer-language independent or dependent and refer to a complete interface, a single function, or even a set of APIs. The service layer (1413) provides software services to the computer (1402) or other components (whether or not illustrated) that are communicably coupled to the computer (1402). The functionality of the computer (1402) may be accessible for all service consumers using this service layer. Software services, such as those provided by the service layer (1413), provide reusable, defined business functionalities through a defined interface. For example, the interface may be software written in JAVA, C++, or other suitable language providing data in extensible markup language (XML) format or other suitable format. While illustrated as an integrated component of the computer (1402), alternative implementations may illustrate the API (1412) or the service layer (1413) as stand-alone components in relation to other components of the computer (1402) or other components (whether or not illustrated) that are communicably coupled to the computer (1402). Moreover, any or all parts of the API (1412) or the service layer (1413) may be implemented as child or sub-modules of another software module, enterprise application, or hardware module without departing from the scope of this disclosure.

The computer (1402) includes an interface (1404). Although illustrated as a single interface (1404) in FIG. 14, two or more interfaces (1404) may be used according to particular needs, desires, or particular implementations of the computer (1402). The interface (1404) is used by the computer (1402) for communicating with other systems in a distributed environment that are connected to the network (1430). Generally, the interface (1404 includes logic encoded in software or hardware (or a combination of software and hardware) and operable to communicate with the network (1430) or cloud. More specifically, the interface (1404) may include software supporting one or more communication protocols associated with communications such that the network (1430) or interface's hardware is operable to communicate physical signals within and outside of the illustrated computer (1402).

The computer (1402) includes at least one computer processor (1405). Although illustrated as a single computer processor (1405) in FIG. 14, two or more processors may be used according to particular needs, desires, or particular implementations of the computer (1402). Generally, the computer processor (1405) executes instructions and manipulates data to perform the operations of the computer (1402) and any algorithms, methods, functions, processes, flows, and procedures as described in the instant disclosure.

The computer (1402) also includes a memory (1406) that holds data for the computer (1402) or other components (or a combination of both) that can be connected to the network (1430). For example, memory (1406) can be a database storing data consistent with this disclosure. Although illustrated as a single memory (1406) in FIG. 14, two or more memories may be used according to particular needs, desires, or particular implementations of the computer (1402) and the described functionality. While memory (1406) is illustrated as an integral component of the computer (1402), in alternative implementations, memory (1406) can be external to the computer (1402).

The application (1407) is an algorithmic software engine providing functionality according to particular needs, desires, or particular implementations of the computer (1402), particularly with respect to functionality described in this disclosure. For example, application (1407) can serve as one or more components, modules, applications, etc. Further, although illustrated as a single application (1407), the application (1407) may be implemented as multiple applications (1407) on the computer (1402). In addition, although illustrated as integral to the computer (1402), in alternative implementations, the application (1407) can be external to the computer (1402).

There may be any number of computers (1402) associated with, or external to, a computer system containing computer (1402), each computer (1402) communicating over network (1430). Further, the term “client,” “user,” and other appropriate terminology may be used interchangeably as appropriate without departing from the scope of this disclosure. Moreover, this disclosure contemplates that many users may use one computer (1402), or that one user may use multiple computers (1402).

In some embodiments, the computer (1402) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, a cloud computing system may operate according to one or more service models, such as infrastructure as a service (IaaS), platform as a service (PaaS), software as a service (Saas), mobile “backend” as a service (MBaaS), artificial intelligence as a service (AIaaS), serverless computing, and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

While the disclosure has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

What is claimed is:

1. A method, comprising:
obtaining acquired seismic data based on a seismic survey regarding a geological region of interest;
generating, by a computer processor, synthetic seismic data for the geological region of interest using a forward modeling function and a velocity model;
determining, by the computer processor, an objective function using the acquired seismic data, the synthetic seismic data, and a convolution function, wherein the objective function compares the acquired seismic data and the synthetic seismic data;
determining, by the computer processor, whether the velocity model satisfies a predetermined criterion based on the objective function;
updating, by the computer processor and in response to determining that the velocity model fails to satisfy the predetermined criterion, the velocity model using a search method and a plurality of gradients to produce an updated velocity model; and
generating, by the computer processor, a seismic image using the updated velocity model.

2. The method of claim 1, further comprising:
determining an adjoint source using the synthetic seismic data and the objective function;
determining adjoint wavefield data for the geological region of interest using the adjoint source, a backpropagation function, and the velocity model; and
determining one or more gradients using the adjoint wavefield data,
wherein the velocity model is updated using the one or more gradients.

3. The method of claim 1,
wherein the acquired seismic data comprises a first plurality of seismic traces,
wherein the synthetic seismic data comprises a second plurality of seismic traces, and
wherein the objective function is determined by performing a convolution of the first plurality of seismic traces and the second plurality of seismic traces using the convolution function.

4. The method of claim 1, further comprising:
determining a selection of a seismic trace from the acquired seismic data;
determining a predetermined number of neighboring traces for the convolution function; and
determining a convolution of the seismic trace with a plurality of seismic traces from the synthetic seismic data based on the predetermined number of neighboring traces and the convolution function.

5. The method of claim 1,
wherein the objective function is determined using a Fast Fourier Transform.

6. The method of claim 1,
wherein the search method is selected from a group consisting of conjugate-gradient method and a quasi-Newton 1-bfgs method.

7. The method of claim 1,
wherein the predetermined criterion is a convergence criterion.

8. The method of claim 1,
wherein the convolution function comprises one or more convolution filters that produce a synthetic seismic trace from a convolution of the convolution function and an acquired seismic trace.

9. The method of claim 1,
wherein the velocity model is updated iteratively until the predetermined criterion is satisfied.

10. The method of claim 1, further comprising:
determining, using the seismic image, a presence of hydrocarbons in the geological region of interest.

11. The method of claim 1, further comprising:
acquiring, using a seismic surveying system, the acquired seismic data regarding the geological region of interest.

12. A system, comprising:
a seismic interpreter comprising a computer processor and memory, wherein the seismic interpreter is configured to:
obtain acquired seismic data based on a seismic survey regarding a geological region of interest;
generate synthetic seismic data for the geological region of interest using a forward modeling function and a velocity model;
determine an objective function using the acquired seismic data, the synthetic seismic data, and a convolution function, wherein the objective function compares the acquired seismic data and the synthetic seismic data;
determine whether the velocity model satisfies a predetermined criterion based on the objective function;
update, in response to determining that the velocity model fails to satisfy the predetermined criterion, the velocity model using a search method and a plurality of gradients to produce an updated velocity model; and
generate a seismic image using the updated velocity model.

13. The system of claim 12, wherein the seismic interpreter is further configured to:
determine an adjoint source using the synthetic seismic data and the objective function;
determine adjoint wavefield data for the geological region of interest using the adjoint source, a backpropagation function, and the velocity model; and
determine one or more gradients using the adjoint wavefield data,
wherein the velocity model is updated using the one or more gradients.

14. The system of claim 12,
wherein the acquired seismic data comprises a first plurality of seismic traces,
wherein the synthetic seismic data comprises a second plurality of seismic traces, and
wherein the objective function is determined by performing a convolution of the first plurality of seismic traces and the second plurality of seismic traces using the convolution function.

15. The system of claim 12, wherein the seismic interpreter is further configured to:
determine a selection of a seismic trace from the acquired seismic data;
determine a predetermined number of neighboring traces for the convolution function; and
determine a convolution of the seismic trace with a plurality of seismic traces from the synthetic seismic data based on the predetermined number of neighboring traces and the convolution function.

16. The system of claim 12,
wherein the objective function is determined using a Fast Fourier Transform.

17. The system of claim 12,
wherein the velocity model is updated iteratively by the seismic interpreter until the predetermined criterion is satisfied.

18. The system of claim 12, wherein the seismic interpreter is further configured to:
determine, using the seismic image, a presence of hydrocarbons in the geological region of interest.

19. The system of claim 12, further comprising:
a seismic surveying system, wherein the seismic surveying system comprises at least one seismic source and a plurality of seismic receivers,
wherein the seismic surveying system acquires the acquired seismic data.

20. A non-transitory computer readable medium storing instructions executable by a computer processor, the instructions when executable by the computer processor are configured to perform a method comprising:
obtaining acquired seismic data based on a seismic survey regarding a geological region of interest;
generating synthetic seismic data for the geological region of interest using a forward modeling function and a velocity model;
determining an objective function using the acquired seismic data, the synthetic seismic data, and a convolution function, wherein the objective function compares the acquired seismic data and the synthetic seismic data;
determining whether the velocity model satisfies a predetermined criterion based on the objective function;
updating, in response to determining that the velocity model fails to satisfy the predetermined criterion, the velocity model using a search method and a plurality of gradients to produce an updated velocity model; and
generating a seismic image using the updated velocity model.
